(19) United States
(12) Patent Application Publication
(10) Pub. No.: US 2025/0111568 A1
(43) Pub. Date: Apr. 3, 2025

(54) TEXT INFORMATION GENERATION DEVICE, TEXT INFORMATION GENERATION METHOD, PROGRAM, AND RECORDING MEDIUM

(71) Applicant: FUJIFILM Corporation, Tokyo (JP)

(72) Inventors: Kei YAMAJI, Saitama-shi (JP); Masaru KOBAYASHI, Saitama-shi (JP); Toshiki KOBAYASHI, Saitama-shi (JP); Yuya NISHIO, Saitama-shi (JP); Kazuya OKIYAMA, Saitama-shi (JP)

(73) Assignee: FUJIFILM Corporation, Tokyo (JP)

(21) Appl. No.: 18/899,747

(22) Filed: Sep. 27, 2024

(30) Foreign Application Priority Data
Sep. 28, 2023 (JP) 2023-167778

(51) Int. Cl. G06T 11/60; G06F 40/109

(52) U.S. Cl. CPC G06T 11/60; G06F 40/109

(57) ABSTRACT

Provided are a text information generation device, a text information generation method, a program, and a recording medium capable of generating an appropriate text in consideration of a background image or an image layout in addition to an image to be disposed on a medium.

A text information generation device according to one embodiment of the present invention includes a processor, in which the processor is configured to execute first acquisition processing of acquiring first information related to at least one of a layout of the image in the background image or the background image, second acquisition processing of acquiring second information related to the image, and generation processing of generating the text information based on the first information and the second information.

### CROSS-REFERENCE TO RELATED APPLICATIONS

The present application claims priority under 35 U.S.C. § 119 to Japanese Patent Application No. 2023-167778, filed on Sep. 28, 2023. The above application is hereby expressly incorporated by reference, in its entirety, into the present application.

### BACKGROUND OF THE INVENTION

### 1. Field of the Invention

One embodiment of the present invention relates to a text information generation device, a text information generation method, a program, and a recording medium capable of generating appropriate text information in consideration of a background image and an image disposed on the background image.

### 2. Description of the Related Art

A technique of extracting, in creating a so-called photo book or the like, a keyword corresponding to an image to be used and disposing the keyword in the image or around the image is already known. An example of such a technique includes the technique disclosed in JP2019-149020A. In the technique disclosed in JP2019-149020A, image data used to create the photo book is analyzed to perform keyword extraction and title decision, and the image and the title are assigned to a design template according to the title. Accordingly, it is possible to create a photo book with good taste without spending time and effort.

### SUMMARY OF THE INVENTION

In the photo book, not only the image but also an atmosphere of a mounting board (hereinafter referred to as background image) that is a disposition destination of the image or a layout of the image on the background image has a considerable influence on an impression of a target page or the entire photo book. In a case where an image size is smaller than a general image size or in a case where the number of images to be disposed is small, the influence of such a background image and layout tends to be larger. Further, in some cases, an atmosphere and an impression that are created from each of the background image or layout and the image may affect each other. Therefore, even in a case where a text is simply generated based on only the image, there is a possibility that the text is not appropriate as a text required to be assigned to the photo book.

On the other hand, in a case where the text is assigned to the image by using the technique disclosed in JP2019-149020A, a keyword extracted without considering the background image or the layout as described above is used. Such a keyword may not match the impression received from the background image or the layout, and may leave a sense of incongruity as the impression of the entire photo book.

One embodiment of the present invention has been made in view of the above circumstances, and an object thereof is to provide a text information generation device, a text information generation method, a program, and a recording medium capable of generating appropriate text information in consideration of a background image and an image disposed on the background image.

The above object is achieved by a text information generation device according to any one of [1] to [9] below.

[1] A text information generation device that generates text information based on a background image and one or more images, the text information generation device comprising a processor, in which the processor is configured to execute first acquisition processing of acquiring first information related to at least one of a layout of the image in the background image or the background image, second acquisition processing of acquiring second information related to the image, and generation processing of generating the text information based on the first information and the second information.

[2] The text information generation device according to [1], in which the processor is configured to execute, in the generation processing, output processing of setting a style based on at least any one of the first information or the second information, and outputting the text information according to the style.

[3] The text information generation device according to [2], in which the first information related to the background image is information related to a color pattern of the background image.

[4] The text information generation device according to any one of [1] to [3], in which the first information related to the layout is information related to a blank region in which the image is not disposed in the background image.

[5] The text information generation device according to [4], in which the processor is configured to decide, in the generation processing, at least one of the number of characters of a text included in the text information or a display size of the text based on a size of the blank region.

[6] The text information generation device according to any one of [1] to [5], in which the processor is configured to generate, in the generation processing, the text information based on the first information related to the layout, a rule for generating the text information according to the layout, and the second information.

[7] The text information generation device according to any one of [1] to [6], in which, in a case where the layout is a layout in which two or more images of different sizes are disposed on the background image, the processor is configured to generate, in the generation processing, the text information based on at least the second information related to a largest image.

[8] The text information generation device according to any one of [1] to [7], in which, in a case where the layout is a layout in which two or more images of the same size are disposed on the background image, the processor is configured to generate, in the generation processing, the text information based on the second information related to each of the two or more images.

[9] The text information generation device according to any one of [1] to [8], in which the processor is configured to execute processing of generating an image attached with text information in which the text information is disposed in at least any one of the background image or the image, and further execute processing of deciding a disposition method of a text indicated by the text information in the image attached with text information based on at least one of the first information or the second information.

Further, the above object is also achieved by the following text information generation method according to [10].

[10] A text information generation method of generating text information based on a background image and one or more images by a processor, the text information generation method comprising, by the processor, a step of acquiring first information related to at least one of a layout of the image in the background image or the background image, a step of acquiring second information related to the image, and a step of generating the text information based on the first information and the second information.

Further, a program according to one embodiment of the present invention is a program for causing a computer to execute each of the steps included in the text information generation method described in [10] above.

Further, a recording medium according to one embodiment of the present invention is a computer-readable recording medium on which a program for causing a computer to execute each of the steps included in the text information generation method described in above is recorded.

According to one embodiment of the present invention, there are provided the text information generation device, the text information generation method, the program, and the recording medium capable of generating the appropriate text information in consideration of the background image and the image disposed on the background image.

### BRIEF DESCRIPTION OF THE DRAWINGS

FIG. 1 is a diagram showing an example of an operation concept of a text information generation device according to a first embodiment of the present invention.

FIG. 2 is a table showing a correspondence relationship between an image analysis result and a content of text information, according to the first embodiment of the present invention.

FIG. 3 is a table showing a correspondence relationship between a layout of a disposition image and a disposition image required to be used to generate text information, according to the first embodiment of the present invention.

FIG. 4 is a table showing a correspondence relationship between the image analysis result and a text style, according to the first embodiment of the present invention.

FIG. 5 is a table showing a correspondence relationship between a blank region and the number of characters or the like of a text, according to the first embodiment of the present invention.

FIG. 6 is a diagram showing a table for determination in which the number of images used to generate the text information and a disposition position of the text information are associated with each other, according to the first embodiment of the present invention.

FIG. 7 is a diagram showing an example of an output image in which texts are disposed, according to the first embodiment of the present invention.

FIG. 8 is a diagram showing a conceptual example of selection of a subject from disposition images according to the first embodiment of the present invention.

FIG. 9 is a diagram showing a concept of text disposition control in accordance with an inclination of a subject in the disposition image according to the first embodiment of the present invention.

FIG. 10 is a diagram showing a hardware configuration example of the text information generation device according to the first embodiment of the present invention.

FIG. 11 is a diagram showing a functional unit of the text information generation device according to the first embodiment of the present invention.

FIG. 12 is a flowchart showing a text information generation method according to the first embodiment of the present invention.

### DESCRIPTION OF THE PREFERRED EMBODIMENTS

Hereinafter, specific embodiments of the present invention will be described.

In the following, for convenience of description, the description may be made in terms of a graphic user interface (GUI). Further, since basic data processing techniques (communication/transmission techniques, data acquisition techniques, data recording techniques, data processing/analysis techniques, machine learning techniques, image processing techniques, visualization techniques, and the like) for implementing the present invention are well-known techniques, the description thereof will be omitted.

Further, in the present specification, the concept of “apparatus” includes a single apparatus that exerts a specific function, and includes a combination of a plurality of apparatuses that exert a specific function in cooperation (coordination) with each other while being distributed and present independently of each other.

Further, in the present specification, a term “user” is a user of the text information generation device according to the embodiment of the present invention, and specifically, for example, a person who uses an image to which text information described below obtained by a function of the text information generation device according to the embodiment of the present invention is assigned (specifically, output image described below).

Further, in the present specification, the term “person” means a main subject that performs specific behavior, may include an individual, a group, a corporation, such as a company, an organization, and the like, and may also further include a computer and a device that constitute artificial intelligence (AI). The artificial intelligence realizes intellectual functions, such as reasoning, prediction, and determination, by using a hardware resource and a software resource. An algorithm of the artificial intelligence is random, and examples thereof include an expert system, a case-based reasoning (CBR), a Bayesian network, or an inclusion architecture.

### First Embodiment of Present Invention

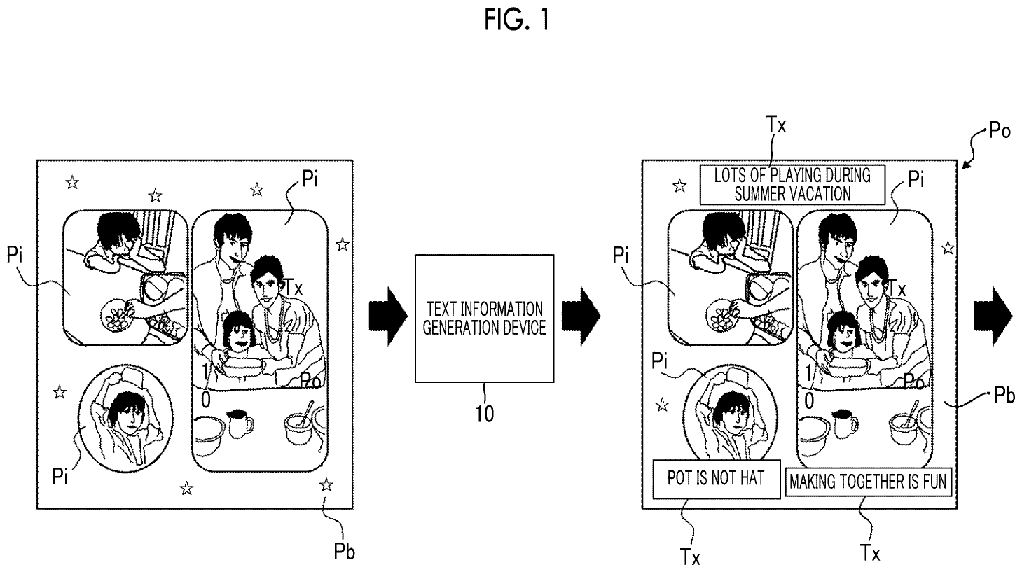

In a first embodiment of the present invention (hereinafter first embodiment), as shown in FIG. 1, a text information generation device according to the embodiment of the present invention generates text information (hereinafter text information Tx) based on a background image Pb, such as a mounting board image, and an image to be disposed on the background image Pb (hereinafter disposition image Pi), and outputs an image including the text information Tx (hereinafter output image Po). The user can use the output image Po.

In order to implement such functions, the text information generation device has functional units such as a reception unit 21, a generation unit 22, a decision unit 23, and an output unit 24 (refer to FIG. 11). Specific functions of these functional units will be sequentially described below.

An example of the output image Po, an image can be assumed in which one or more disposition images Pi are disposed on the background image Pb and the text information Tx is assigned to the background image Pb or the disposition image Pi, or the text information Tx is assigned across the background image Pb and the disposition image Pi.

The assignment (disposition) of the text information Tx on the image means that the text information Tx is converted into an image (text image) and included in the output image Po as a part of the output image Po.

The term “image” in the present invention is configured of a plurality of pixels, is expressed by a gradation value of each of the plurality of pixels, and includes at least one or more subjects. Further, digital image data (hereinafter image data) in which an image is defined at a set resolution is generated by compressing data in which the gradation value for each pixel is recorded by a predetermined compression method. Examples of a type of the image data include irreversible compressed image data, such as joint photographic experts group (JPEG) format, and reversible compressed image data, such as graphics interchange format (GIF) or portable network graphics (PNG) format.

In the following description, in a case where an image is simply referred to as “image”, a concept thereof may include any of the background image Pb, the disposition image Pi, and the output image Po.

### Reception Unit

The reception unit 21 receives an input of the image used to generate the text information. In the first embodiment, a method of acquiring an image in the reception unit 21 is not particularly limited. For example, the method thereof includes receiving image data input of an image captured by an imaging device, such as a camera, through a predetermined interface and communication line, and receiving reading data of an existing photograph by a scanner or the like from a device such as the scanner, by the reception unit 21.

Further, in a case where the imaging device is mounted on the text information generation device, the reception unit 21 may acquire the image data of the image captured by the imaging device. Further, the reception unit 21 may download the image data from an external device, a web server, or the like via a communication network to acquire the image.

The image data acquired by the reception unit 21 is assumed to be a material for producing the photo book or the like, but the present invention is not limited thereto. Any of the image data can be applied as long as the image data is disposed on the background image and is used to produce or edit any electronic medium.

Further, the disposition image Pi may be a developed image obtained by developing a RAW image or may be a correction image obtained by performing predetermined correction processing on the developed image. The developed image or the correction image as the disposition image Pi is one or a plurality of images disposed in a predetermined layout with respect to the background image Pb (refer to FIG. 1).

The background image Pb is an image on which the disposition image Pi is disposed (superimposed) on the background image Pb, and functions as a mounting board for the disposition image Pi. The background image Pb is an image having a larger size than the disposition image Pi, has a tint, and may be a black and white image or a color image. Further, a pattern may be applied to the background image Pb, or an illustration such as a character may be drawn as one aspect of the pattern.

The output image Po is an image in which one or a plurality of disposition images Pi are disposed in the predetermined layout with respect to the background image Pb. The output image Po includes one or more image regions, a blank region Pv other than the image region, and further includes the text information Tx. The image region is a region in the background image Pb on which the disposition image Pi is disposed. The blank region Pv is a region in the background image Pb in which the disposition image Pi is not included. In a case of the image of each page constituting the photo book, a region in which there is no image on the page, that is, a blank corresponds to the blank region Pv.

The layout is a disposition layout of the disposition image Pi in the background image Pb. The layout may include the number of disposition images Pi, a size, disposition position, outer edge shape (aspect ratio) of each disposition image Pi, an inclination of the disposition image Pi with respect to the background image Pb (that is, rotation amount of disposition image Pi), and the like.

### Output Unit

The output unit 24 outputs the output image Po including the text information Tx generated by the generation unit 22. In the first embodiment, a method of outputting the output image Po is not particularly limited. For example, the method thereof includes displaying the output image Po on a display or monitor, printing the output image Po, transmitting the output image Po to another user, and providing the output image Po as a commercial product, by the output unit 24 in the text information generation device.

The output image Po as the commercial product is assumed to be a booklet (medium) consisting of a plurality of pages on which images are posted, such as an album, a photo book, a postcard, a message card, and an electronic album.

Further, an aspect in which the output image Po is provided as the commercial product may include, in addition to an aspect in which the output image Po is printed on a medium such as paper to be provided, an aspect in which the image data (digital data) is provided in a form of an electronic commercial product without performing the printing on the medium. Further, an aspect in which the printed output image Po is provided may include transmitting the medium, such as paper, on which the output image Po is printed to a providing destination as a message card or a postcard. Furthermore, a method of outputting the output image Po may include posting and publishing the output image Po to a social networking service (SNS).

The output unit 24 outputs the output image Po as an image including the text information Tx. The text information Tx is information displaying a text related to the disposition image Pi (character information), and specifically, is information indicating a sentence (text) according to the subject in one or a plurality of disposition images Pi. For example, the text information Tx displays the text such as a comment and a message to the subject, a description of the subject, and a remark uttered by the subject. The text indicated by the text information Tx is configured of a phrase consisting of one or more words or a sentence. Further, in a case where the sentence is divided, each of a plurality of divided phrases may correspond to the text. Furthermore, the text indicated by the text information Tx may include a mimetic word, an onomatopoeia, an interjection, and the like.

### Generation Unit

In the first embodiment, the generation unit 22 of the text information generation device automatically generates the text information Tx. In generating the text information Tx automatically, the generation unit 22 of the text information generation device generates the text information Tx based on first information related to at least one of the layout of the disposition image Pi in the background image Pb or the background image Pb and second information related to the disposition image Pi.

The generation unit 22 is assumed to perform analysis on at least one of the layout or the background image Pb to acquire the first information described above. Similarly, the generation unit 22 is assumed to perform analysis on the disposition image Pi to acquire the second information.

Such analysis is, for example, specifying a feature of each event related to the image. Examples of such a feature include, in each region of the image, information related to a hue and a tone, information related to image quality, a gradation value of a pixel, a size and position of the blank region, a layout of the disposition image Pi (for example, the number of dispositions of images, a disposition spacing, a disposition shape, a size, and a size variation), and information on the subject estimated from these pieces of information. The information on the subject may include a type of the subject, a state of the subject, a position of the subject in the image, and in a case where the subject is a person, a facial expression, a pose, a gesture, an age group, a gender, and the like.

Further, it is desirable that the feature of the image can be digitized, vectorized, or tensorized. In this case, an analysis result of the image is the feature of the digitized, vectorized, or tensorized image, that is, a feature amount.

The subject means a person, an animal, an object, a background, and the like, which are included in the disposition image Pi. Further, a concept of the subject may include a place appearing in the disposition image Pi, a scene (for example, dawn or dusk and fine weather), and a theme (for example, event such as a trip, a meal, or a sports day). The disposition image Pi may be a landscape image. That is, the subject included in the disposition image Pi may be only the landscape, and the entire image may represent the landscape as the subject.

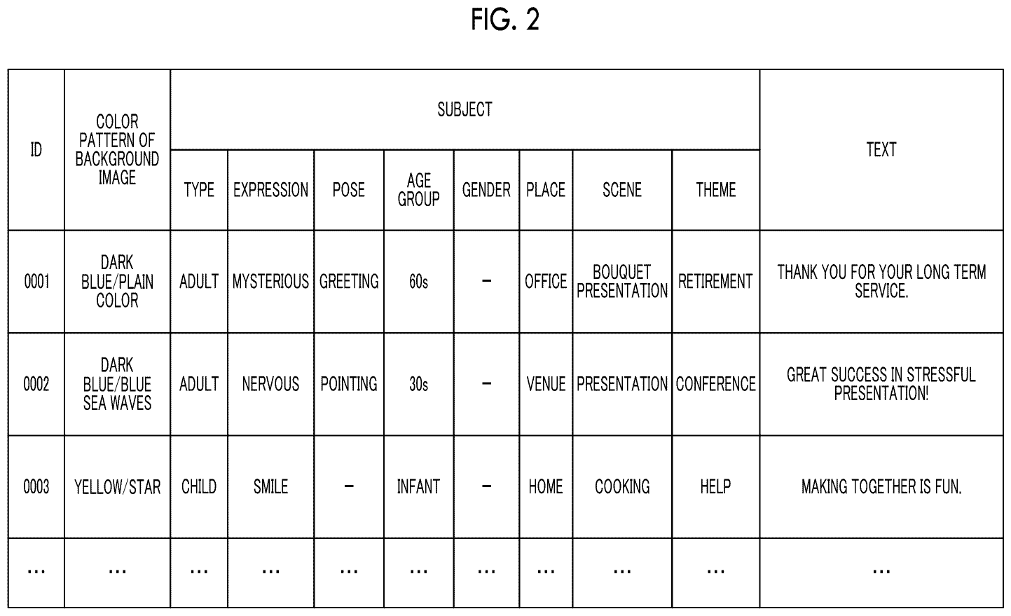

A technique for automatically generating the text from the analysis result of the image is not particularly limited. For example, a correspondence relationship between the image analysis result and the content of the text information Tx (refer to FIG. 2) may be stored as data, and the generation unit 22 may select (generate) the text information Tx corresponding to the image analysis result with reference to the correspondence relationship.

As shown in FIG. 2, in the correspondence relationship between the image analysis result and the content of the text information Tx, for example, the image analysis results and the contents of the text information Tx (specifically, texts indicated by the text information Tx) of the background image Pb and the disposition image Pi are associated with each other. Examples of the image analysis result include a color pattern of the background image Pb and a type, expression, pose, attribute (age group and gender), imaging place, scene, and theme of the subject included in the disposition image Pi. In the example shown in FIG. 2, the image analysis results are associated with the text information Tx such as “Happy birthday! You can crawl well”, “Lots of fun at park pool during summer vacation”, “Sunset over the Sea of Japan is special”, “Hole-in-one in rain!?”, “Look over here, Mom!”, “Thank you for your many years of service”, “Congratulations on your new house!”, and “Wow, that's amazing”.

Alternatively, a learning model for text generation may be constructed by performing machine learning, and the generation unit 22 may input the image to the learning model to generate the text information Tx related to the image. The learning model described above specifies the feature of the input image and generates the text information Tx according to the feature. The learning model is constructed by performing machine learning using, as learning data, the image acquired in the past and the text information assigned to the image.

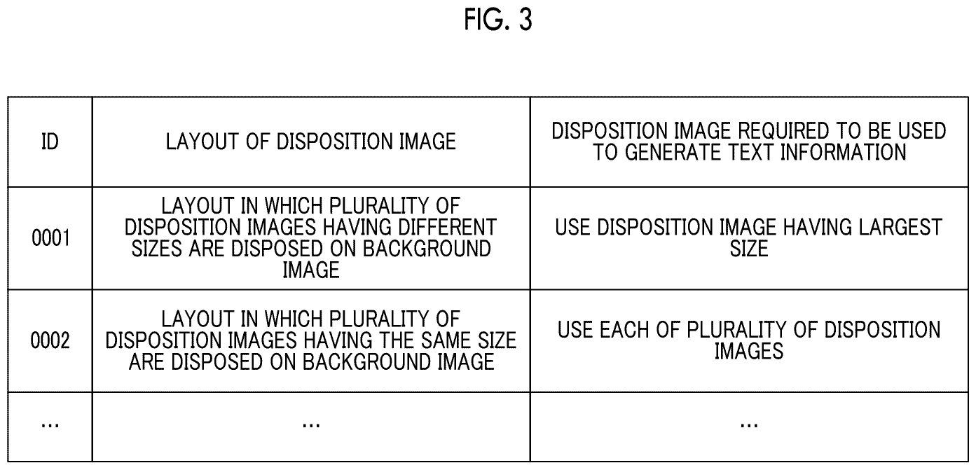

In generating the text information Tx in the generation unit, an aspect may be employed in which the image analysis result used to generate the text information Tx, among the image analysis results, is selectively used based on the layout of the disposition image Pi. In this case, as a rule for generating the text information Tx according to the layout, the text information generation device may store a correspondence relationship between the layout of the disposition image Pi and the disposition image Pi required to be used to generate the text information Tx (refer to FIG. 3) as data, and the generation unit may select the disposition image Pi to be a target of the image analysis result with reference to the correspondence relationship.

As shown in FIG. 3, in the correspondence relationship described above, the layout of the disposition images Pi is associated with a selection method of the disposition image Pi. In the correspondence relationship shown in FIG. 3, the layout of the disposition image Pi includes a layout in which a plurality of disposition images Pi having different sizes are disposed on the background image Pb, a layout in which a plurality of disposition images Pi having the same size are disposed on the background image Pb, and the like. Further, in the correspondence relationship shown in FIG. 3, the selection method of the disposition images Pi includes a case where the disposition image Pi having a largest size among the plurality of disposition images Pi is selected and a case where each of the plurality of disposition images Pi is selected. In a case where such a correspondence relationship is used, the text information Tx is generated based on identity in terms of the size in the plurality of disposition images Pi.

A concept of any of the total number of pixels, the number of pixels in a vertical direction or a horizontal direction, or the number of pixels in a long side may be employed as the size of the disposition image Pi.

Further, the concept that the sizes of the disposition images Pi are the “same” is a difference that cannot be visually perceived, for example, a concept with a condition that a difference in size between a target image and a comparison target image is smaller than a predetermined value (for example, ratio, number of pixels, or area).

### Decision Unit

In the first embodiment, the decision unit 23 of the text information generation device can also set a style of the text information Tx generated in the manner described above. The style corresponds to a font type, display color, display size, and presence or absence of decoration of the text indicated by the text information Tx, presence or absence of an object for text display, such as a balloon, and an object type.

The decision unit 23 of the text information generation device performs the setting of the style described above based on, for example, at least any one of the first information (information related to at least any one of the layout of the disposition image Pi in the background image Pb or the background image Pb) or the second information (information related to the disposition image Pi).

Specifically, for example, the decision unit 23 of the text information generation device inputs, to the learning model that has been trained in advance, at least any one of the information (first information) related to at least any one of the layout of the disposition image Pi on the background image Pb or the background image Pb, or the information (second information) related to the disposition image Pi to decide a corresponding style.

This learning model is a model for style setting that is constructed by performing the machine learning using, as training data, a set of at least any one of the background image Pb or the background image Pb on which the disposition image Pi is disposed, at least any one of the disposition images Pi, which are used in the past or prepared for learning, and an appropriate style of the text information Tx.

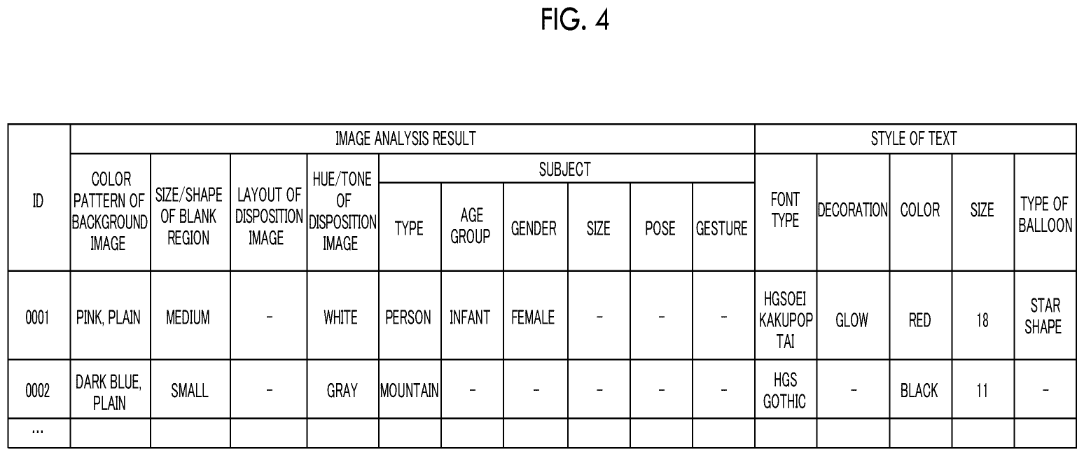

Alternatively, a correspondence relationship (refer to FIG. 4) between at least any one of the first information or the second information, that is, the image analysis results of only the background image Pb, the background image Pb on which the disposition image Pi is disposed, and the disposition image Pi and the style of the text information Tx may be stored as data, and the decision unit 23 may select the style corresponding to at least any one of the first information or the second information (image analysis result) with reference to the correspondence relationship.

As shown in FIG. 4, in the correspondence relationship between the image analysis result and the style, the image analysis results related to the background image Pb, the disposition image Pi, and the layout of the disposition image Pi are associated with the style. In the correspondence relationship shown in FIG. 4, the image analysis result of the background image Pb includes, for example, the color pattern of the background image Pb and a size or shape of the blank region. The analysis result of the layout of the disposition image Pi includes, for example, the number of dispositions of the disposition image Pi, the disposition spacing, and the disposition shape. The analysis result of the disposition image Pi includes, for example, an overall hue and tone of the disposition image Pi and the attribute (for example, type, age group, gender, size, pose, and gesture) of the subject. Further, in the correspondence relationship shown in FIG. 4, the style of the text information Tx includes the font type of the text indicated by the text information Tx, the decoration at the time of display, the display color, the display size, the object type such as a balloon, and the like.

Further, the decision unit 23 of the text information generation device can perform control of generating the text information Tx based on attribute information related to the blank region Pv generated in the background image Pb as the information related to the background image Pb. The attribute information related to the blank region Pv is information related to the blank region Pv, such as a size of the blank region Pv and a position of the blank region Pv in the background image Pb (hereinafter referred to as position).

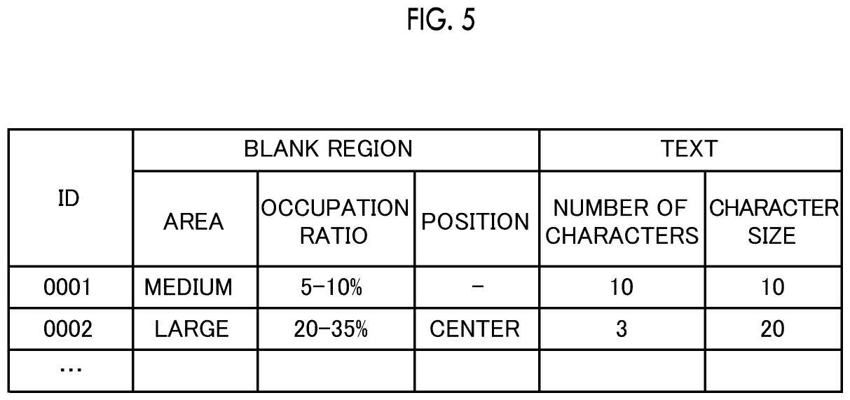

Therefore, the text information generation device may store a correspondence relationship between the size and position of the blank region Pv and the number of characters and display size of the text indicated by the text information Tx (refer to FIG. 5) as data, and the decision unit may decide the number of characters or the like of the text to be disposed in the blank region Pv with reference to the correspondence relationship.

As shown in FIG. 5, in the correspondence relationship described above, the information related to the blank region Pv in the background image Pb is associated with the attribute information related to the text indicated by the text information Tx. The information related to the blank region Pv includes an area of the blank region Pv, an occupation ratio (area basis) and position (for example, central portion, upper portion, or lower portion of background image Pb) of the blank region Pv in the background image Pb, and the like. The attribute information of the text includes the number of characters (for example, 10 characters or less and 20 characters or less), character size (for example, 3 points, 5 points, and 10 points), and the like of the text indicated by the text information Tx.

Further, in a case where the output image Po as an image attached with text information in which the text information Tx is disposed in at least any one of the background image Pb or the disposition image Pi is generated, the decision unit 23 of the text information generation device decides a disposition method of the text information Tx. A concept of the disposition method of the text information Tx may also include a disposition method of the text information Tx in the background image Pb or the disposition image Pi (including concept of being across both images).

The decision of the disposition method by the decision unit 23 is executed based on at least any one of the first information (image analysis result of at least one of the layout of the disposition image Pi in the background image Pb or the background image Pb) or the second information (image analysis result of the disposition image Pi). That is, the disposition of the text information Tx in the output image Po is decided based on at least any one of the first information or the second information.

In this case, the decision unit 23 of the text information generation device performs determination, regarding the disposition method of the text information Tx, based on the image used to generate the text information Tx (at least any one of the disposition image Pi or the background image Pb) and the layout of the disposition image Pi. The disposition method specified by the above determination may include a concept of at least one of the disposition position or a disposition direction of the text information Tx.

The disposition position of the text information Tx may include a concept of a preset defined position (for example, any one of center, upper end, lower end, left end, right end, or corner of image) in at least any one of the background image Pb or the disposition image Pi, a position according to a specific subject included in the disposition image Pi, or the like. Examples of the specific subject include a main subject among the subjects included in the disposition image Pi, specifically, a subject disposed at a center of an angle of view, a subject captured at a largest size, or a subject in focus.

Further, the disposition direction of the text information Tx means an inclination (rotation) of the text information Tx on an image at a disposition destination.

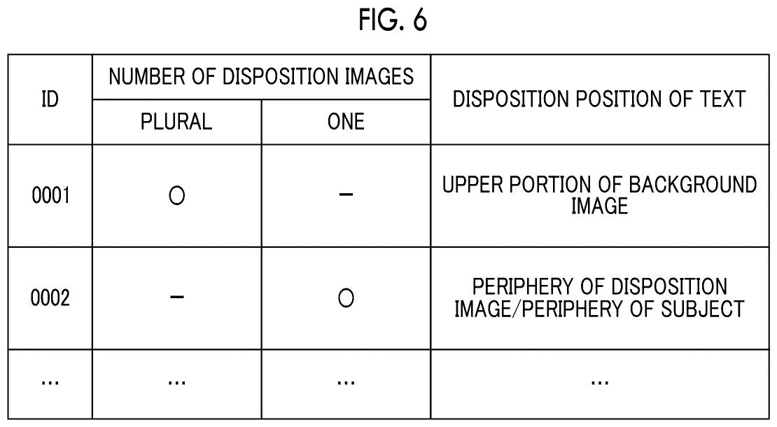

The decision unit 23 of the text information generation device that decides the disposition method decides the disposition position of the text information Tx using a table for determination or an algorithm for determination shown in FIG. 6. In the table of FIG. 6, the number of the disposition images Pi used for the text information Tx (in other words, the number of the disposition images Pi disposed on the background image Pb) is associated with the disposition position of the text information Tx. In the table shown in FIG. 6, the disposition position of the text information Tx includes the upper portion of the background image Pb, a periphery of the disposition image Pi, a periphery of the subject in the disposition image Pi, and the like.

In the above case, for example, the decision unit 23 of the text information generation device decides the disposition position of the text information Tx in accordance with information indicating whether the plurality of images (the background image Pb or the disposition image Pi) or one image is used to generate the text information Tx with reference to the table for determination described above.

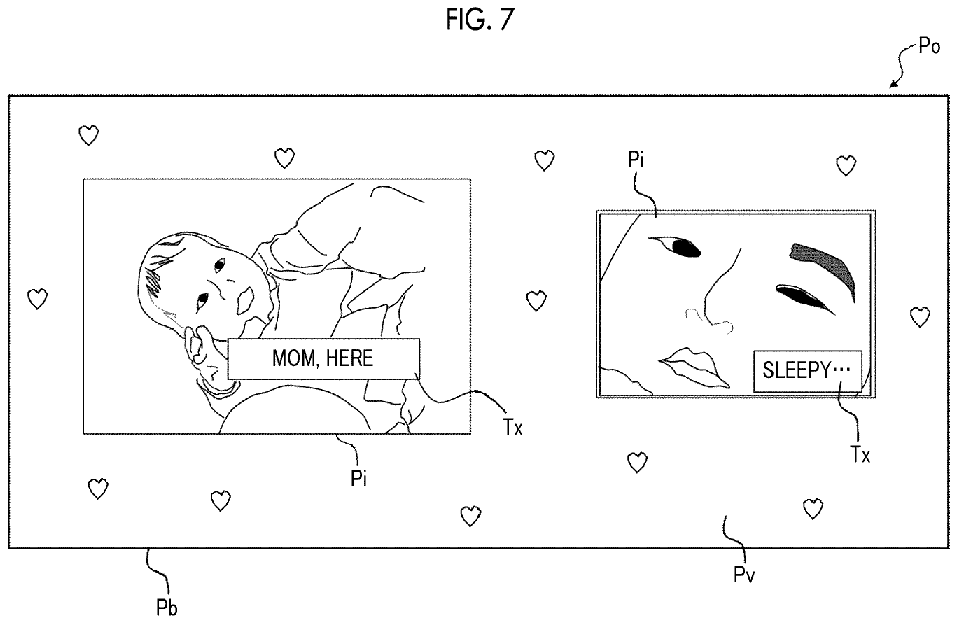

In a case where the definition is made for the periphery of the subject as the disposition position in the table for determination, the decision unit 23 of the text information generation device specifies the subject in the disposition image Pi, and the output unit 24 outputs the output image Po in which the text information Tx is disposed at a position (for example, above, below, left, or right of contour of subject image) according to the subject specified by the decision unit (refer to FIG. 7). Accordingly, it is possible to dispose the text information Tx at an appropriate position in the output image Po in consideration of the subject in the disposition image Pi.

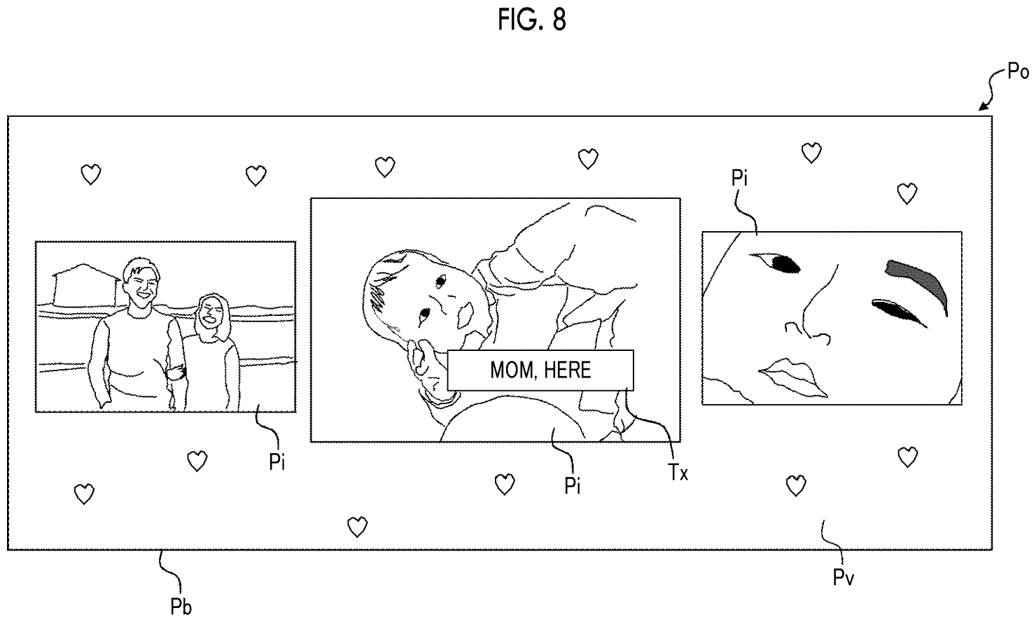

Specifically, it is possible to dispose the text information Tx at a position where the subject and the text information Tx can be easily associated with each other, such as the periphery of the subject. In a case where a plurality of subjects are present in the disposition image Pi, the decision unit of the text information generation device selects a specific subject (for example, subject having a maximum size in image, subject present in center of image, or subject positioned in center of a plurality of subjects) based on a preset rule, and decides the disposition position of the text information Tx around the subject (refer to FIG. 8).

In a case where the control of the disposition method based on the disposition image Pi including the plurality of subjects is performed as described above, the effect of disposing the text information Tx at an appropriate position in the output image Po in consideration of the subject in the disposition image Pi is further enhanced. Specifically, it is possible to suppress the disposition of the text information Tx near the subject having a low relationship with the content of the text information Tx. Further, since the disposition of the text information Tx is automatically decided by the function of the text information generation device, the user does not need to decide the disposition of the text information Tx, and thus the time and effort can be omitted.

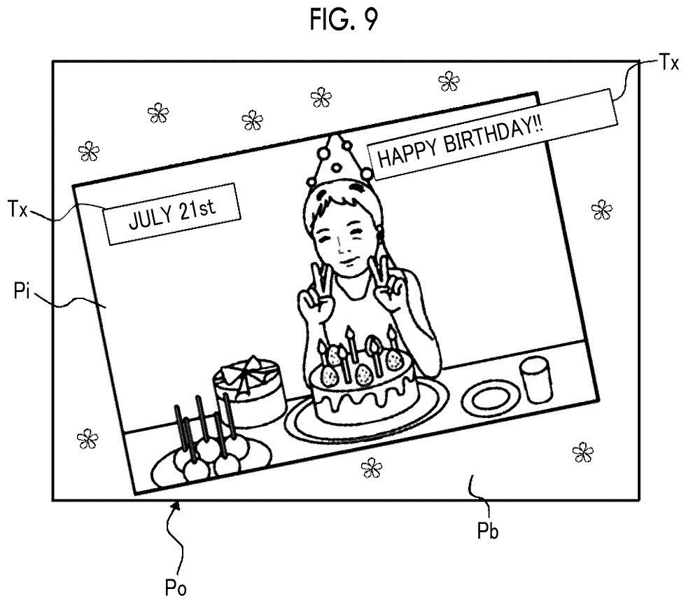

In the disposition method, in deciding the disposition direction, the decision unit 23 of the text information generation device determines the inclination (rotation) of the disposition image Pi used to generate the text information Tx on the background image Pb, and performs control of inclining the text information Tx in accordance with the inclination. Further, instead of the inclination of the disposition image Pi, the inclination of the subject in the disposition image Pi may be determined, and the control of inclining the text information Tx may be performed in accordance with the inclination (refer to FIG. 9).

The technique of specifying the image (disposition image Pi or background image Pb) to which the text information Tx is assigned or specifying the layout of the disposition image Pi to decide the disposition position of the text information Tx accordingly is not limited to the table for determination and the algorithm for determination described above. For example, in addition to what has already been mentioned, the machine learning may be implemented to construct a learning model for disposition position decision of the text information Tx, and the decision unit 23 may input the image (at least one of the background image Pb or the disposition image Pi) to this learning model to decide the disposition position of the text information Tx in the image. A target for which the disposition position is decided may include the subject in the disposition image Pi. Such a learning model is constructed, for example, by performing the machine learning using, as learning data, an image without text acquired in the past and an image attached with text in which the text information Tx is disposed in association with the image or a subject in the image.

Further, the machine learning may be performed stepwise. Specifically, first learning for constructing the learning model that specifies the subject in the image and second learning for constructing the learning model that decides the disposition position of the text information according to the subject may be performed separately.

Furthermore, in the first learning, an Attention mechanism of deep learning may be applied to construct the learning model that specifies the subject based on the process of generating the text information with the learning model for text generation described above. In this case, in a case where the text information to be assigned to the image is generated by using the learning model for text generation, it is possible to reflect, in a case where the subject is specified, which analysis result of which region in the image is focused on to generate the text information.

### Configuration Example of Text Information Generation Device

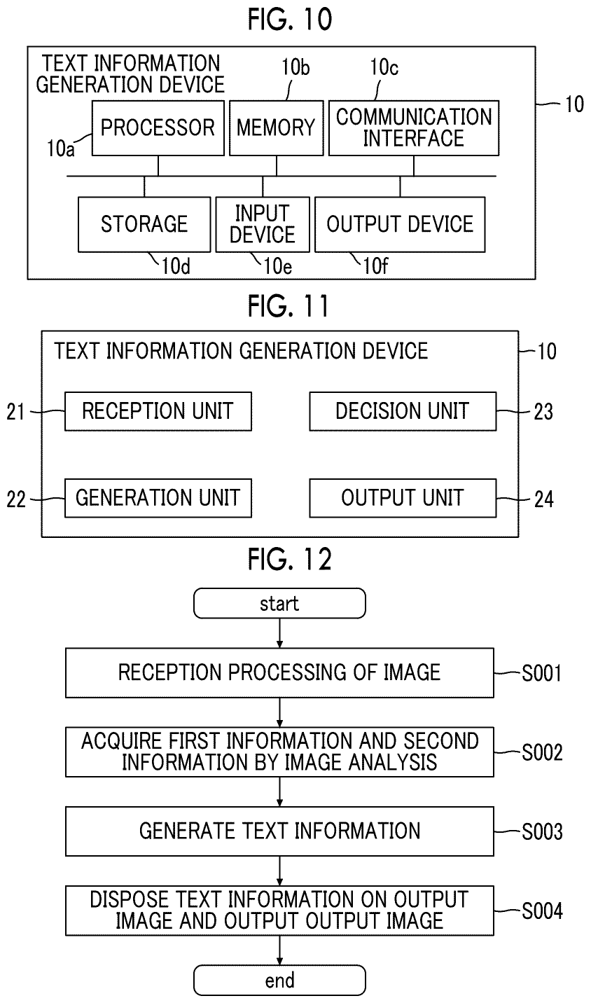

Next, a configuration example of the text information generation device (hereinafter referred to as text information generation device 10) according to the first embodiment will be described with reference to FIG. 10.

The text information generation device 10 is configured of a computer used by the user, specifically, a client terminal, and is specifically configured of a smartphone, a tablet terminal, a notebook personal computer (PC), or the like. The text information generation device 10 is not limited to the computer owned by the user, and may be configured of a terminal that is not owned by the user, such as a store-installed terminal, which is available by inputting a personal identification number, a password, or the like in a case where the user visits a store or the like, or by making a deposit or the like.

In the following, a case where the text information generation device 10 is configured of the computer owned by the user, specifically, the smartphone will be described as an example.

As shown in FIG. 10, the computer constituting the text information generation device 10 comprises a processor 10a, a memory 10b, a communication interface 10c, a storage 10d, an input device 10e, and an output device 10f.

The processor 10a is configured of, for example, a central processing unit (CPU), a micro-processing unit (MPU), a micro controller unit (MCU), a graphics processing unit (GPU), a digital signal processor (DSP), a tensor processing unit (TPU), or an application specific integrated circuit (ASIC).

The memory 10b is configured of, for example, a semiconductor memory such as a read only memory (ROM) and a random access memory (RAM).

The communication interface 10c may be configured of, for example, a network interface card or a communication interface board. The computer constituting the text information generation device 10 can communicate with other devices connected to the communication network, such as the Internet and a mobile communication line, via the communication interface 10c.

The storage 10d is configured of, for example, a flash memory, a hard disc drive (HDD), a solid state drive (SSD), a flexible disc (FD), a magneto-optical disc (MO disc), a compact disc (CD), a digital versatile disc (DVD), a secure digital card (SD card), a universal serial bus memory (USB memory), or the like.

The storage 10d may be built into a computer main body constituting the text information generation device 10, or may be attached to the computer main body in an external form. Alternatively, the storage 10d may be configured of a network attached storage (NAS) or the like. Further, the storage 10d may be an external device that can communicate with one computer constituting the text information generation device 10 through the communication network, such as an online storage or a database server.

The input device 10e is a device that receives an input operation of the user, and is configured of, for example, a touch panel or the like. Further, the input device 10e includes the imaging device, such as a smartphone built-in camera, and a microphone for sound collection.

The output device 10f is configured of, for example, a display.

Further, a program for an operating system (OS) and an application program for image processing execution including text information generation processing are installed in the computer constituting the text information generation device 10 as software. These programs are read out and executed by the processor 10a to cause the computer constituting the text information generation device 10 to exert each function of the reception unit 21, the generation unit 22, the decision unit 23, and the output unit 24 (refer to FIG. 11) described above and specifically, to execute a series of pieces of processing related to the output of the image including the text.

As shown in FIG. 11, the text information generation device 10 includes the reception unit 21, the generation unit 22, the decision unit 23, and the output unit 24. These functional units are realized by the processor 10a of the text information generation device 10 executing the application program for image processing described above and cooperating with another hardware device of the text information generation device 10. Further, some functions may be realized by using artificial intelligence (AI).

### Example of Text Information Generation Method According to First Embodiment

Next, as an operation example of the text information generation device 10 according to the first embodiment, an image processing flow using the same device will be described. In the image processing flow described below, a text information generation method according to the embodiment of the present invention is used. That is, each step in the image processing flow described below corresponds to a component of the text information generation method according to the embodiment of the present invention.

The following flow is merely an example. Some steps in the flow may be deleted, a new step may be added to the flow, or an execution order of two steps in the flow may be exchanged, within a range not departing from the spirit of the present invention.

Each step in the image processing flow according to the first embodiment is implemented by the processor 10a provided in the text information generation device 10 in an order shown in FIG. 12. That is, in each step in the image processing flow, the processor 10a executes processing corresponding to each step in FIG. 12 among data processing defined in the application program for image processing.

Specifically, in the image processing flow according to the first embodiment, first, the processor 10a executes reception processing of the image (S001). In the above reception processing, the processor 10a receives the input of the image to which the text is to be assigned in the present flow, in other words, acquires the background image Pb and the disposition image Pi as processing targets. In this case, the above images may be input in a state in which the disposition image Pi is disposed on the background image Pb (that is, as one input image), or may be input in a state in which the disposition image Pi is separated from the background image Pb.

Next, the processor 10a executes acquisition processing of acquiring the first information related to at least one of the layout of the disposition image Pi in the background image Pb or the background image Pb and the second information related to the disposition image Pi (S002). In the acquisition processing, the processing of acquiring the first information corresponds to first acquisition processing, and the processing of acquiring the second information corresponds to second acquisition processing.

In the acquisition processing, the processor 10a inputs each of the background image Pb on which the disposition image Pi is disposed and the disposition image Pi to an image analysis program that is held or available to call. Accordingly, each image is analyzed to specify the feature of each image, and the processor 10a acquires the specified feature as the first information and the second information.

In the analysis described above, for example, the processor 10a acquires, in each region of the image (specifically, the background image Pb or the disposition image Pi, and the same applies hereinafter), the information related to the hue and the tone, the information related to the image quality, the gradation value of the pixel, and the information related to the size and position of the blank region (which may configure any one or both of the first information and the second information). Further, in the analysis described above, the processor 10a further acquires the information related to the layout of the disposition image Pi (information that may configure the first information, such as the number of dispositions, disposition spacings, disposition shapes, sizes, and size variations of the images) and the information on the subject estimated from these pieces of information (information that may configure the second information).

The information on the subject described above may include the type of the subject, the state of the subject, the position of the subject in the image, and in a case where the subject is a person, the facial expression, the pose, the gesture, the age group, the gender, and the like.

Next, the processor 10a automatically generates the text information Tx based on the first information and the second information obtained in step S002 (S003).

In the automatic generation, the processor 10a performs the analysis on at least one of the layout or the background image Pb to acquire the first information. Similarly, the processor 10a performs the analysis on the disposition image Pi to acquire the second information. As the image analysis method for analyzing the feature of the image, an existing technique can be appropriately employed.

In automatically generating the text information Tx, the processor 10a refers to the correspondence relationship between the image analysis result and the content of the text information Tx (refer to FIG. 2) to generate the text information Tx corresponding to the image analysis results acquired as the first information and the second information, for example.

The text information Tx generated by the above procedure reflects the background image Pb and the layout of the disposition image Pi in the background image Pb.

Specifically, the color pattern of the background image Pb is an element that greatly affects, due to tendency or the like of the color pattern thereof, the impression of the disposition image Pi disposed thereon or a medium or the like generated by disposing the disposition image Pi on the background image Pb. For example, in a case where the color of the background image Pb is dark blue, dark purple, or gray, and the pattern is a Japanese pattern (for example, hemp leaves, blue sea waves, or waves and plovers), the impression received by a person who sees the background image Pb is likely to be calm, traditional, dignified, disciplined, and the like.

On the other hand, in a case where the color of the background image Pb is pink, sky blue, or gold, and the pattern is a pop pattern (for example, a star, a heart, a note, or a puppy), the impression received by a person who sees the background image Pb is likely to be cheerful, young, dynamic, free, cute, and the like.

Further, regarding the disposition image Pi disposed in such a background image Pb, the type, expression, pose, age group, gender, place, scene, and theme of the subject included in the disposition image Pi are elements that greatly affect the impression of the disposition image Pi or the medium or the like generated by disposing the disposition image Pi on the background image Pb, in addition to the number of disposition images Pi and the disposition pattern. From the viewpoint of the influence on such an impression, depending on a combination of the impression related to the disposition image Pi and the impression related to the background image Pb, the overall impression of an edited image in which the disposition image Pi is disposed on the background image Pb may be considered to be changed. The text information Tx is assumed to be set, in the correspondence relationship between the image analysis result and the content of the text information Tx, including a viewpoint of a combination of such first information and second information.

For example, it is assumed that the color pattern of the background image Pb is calm, the disposition layout of the disposition images Pi in the background image Pb is conservative, and the disposition images Pi are spread over the background image Pb vertically and horizontally. Further, respective analysis results showing that the subject in the image is a middle-aged man, the place is an office, and the scene is a scene of presenting a bouquet are assumed to be obtained for the disposition image Pi. In this case, as the generated text information Tx, a sentence with polite and calm phrase and tone that imagines a farewell party for a retiree, for example, text information such as “Thank you for your long-term service.” is generated.

On the other hand, it is assumed that the color pattern of the background image Pb is flashy and pop, and the disposition pattern of the disposition images Pi in the background image Pb is sharp, for example, a large number of disposition images Pi are randomly disposed in the background image Pb. Further, respective analysis results showing that the subject in the image is a female student, the place is a concert venue, and the scene is a scene in which an audience dances in response to performance are assumed to be obtained for the disposition image Pi. In this case, as the generated text information Tx, a sentence with cheerful and casual phrase and tone that imagines viewing of a music festival or the like, for example, text information such as “Too fun with best music!” is generated.

As described above, such a text generation method can also be replaced with a learning model for text generation constructed by the machine learning. That is, the processor 10a may input, to the learning model, the background image Pb (at least any one of the background image Pb alone or the background image Pb on which the disposition image Pi is disposed) and the disposition image Pi to generate the text information Tx related to the images. The learning model described above specifies the feature of the input image and generates the text information Tx according to the feature. The learning model is constructed by performing the machine learning using, as learning data, the image acquired in the past and the text information assigned to the image.

Subsequently, the processor 10a converts the text information Tx generated in step S003 into an image (text image), disposes the text image on the output image Po, and outputs the output image Po (S004). Step S004 corresponds to output processing.

The output image Po in which the text information Tx is disposed is assumed to be, for example, an image in which the disposition image Pi is disposed on the background image Pb and the text information Tx is assigned on the background image Pb or the disposition image Pi or assigned across the background image Pb and the disposition image Pi.

The image processing flow according to the first embodiment ends at a point in time at which the series of pieces of processing described above ends. In a case where the image input is received, the image processing flow is implemented each time the image input is received. That is, the series of pieces of processing described above is repeatedly executed by the processor 10a each time a new image input is received.

### Modification Example of First Embodiment

The first embodiment of the present invention is not limited to the above embodiment, and for example, the following modification examples may be considered. Hereinafter, the modification examples thereof will be described. In the following, differences between the modification examples and the first embodiment described above will be described.

### About First Modification Example

In the first embodiment described above, the text information generation device 10 generates (acquires) the text information Tx and outputs the output image Po on the premise that only one disposition image Pi is disposed on the background image Pb or one disposition image Pi is initially decided as the processing target. However, the present invention is not limited thereto, as the modification example of the first embodiment, an aspect can be assumed in which a plurality of disposition images Pi are disposed on a background image Pb and the text information generation device proactively selects one of the plurality of disposition images Pi as an image used to generate the text information Tx.

In this case, in generating the text information Tx, the processor 10a selectively uses the image analysis result, which is used to generate the text information Tx, based on the layout of the disposition image Pi. Specifically, as a rule for generating the text information Tx according to the layout of the disposition image Pi, the processor 10a stores the correspondence relationship between the layout and the disposition image Pi required to be used to generate the text information Tx (refer to FIG. 3), and selects the disposition image Pi to be analyzed for generating the text information with reference to the correspondence relationship.

As a selection method in that case, for example, in a case of a layout in which a plurality of disposition images Pi having different sizes are disposed on the background image Pb, the processor 10a may select the disposition image Pi having a largest size among the plurality of disposition images Pi. Further, for example, in a case of a layout in which a plurality of disposition images Pi having the same size are disposed on the background image Pb, the processor 10a may selectively execute two types of logic of selecting each of the plurality of disposition images Pi.

### About Second Modification Example

The above style may be set for the text information Tx generated in the first embodiment described above. As a second modification example for the first embodiment, a form will be described in which the style of the text information Tx is set. In the second modification example, the processor 10a performs the setting of the style based on, for example, at least any one of the first information (information related to at least any one of the layout of the disposition image Pi in the background image Pb and the background image Pb) or the second information (information related to the disposition image Pi).

Specifically, the processor 10a inputs, to the learning model that has been trained in advance, at least any one of the first information related to at least one of the layout of the disposition image Pi in the background image Pb or the background image Pb, or the second information related to the disposition image Pi to decide the corresponding style.

For example, the processor 10a may input the analysis results of the background image Pb and the disposition image Pi to the above learning model to output the information related to the style, such as the font type, decoration, color, size, and object type, such as a balloon, of the text indicated by the text information Tx. Examples of the image analysis result input to the learning model include the color pattern of the background image Pb, the size and shape of the blank region, the layout of the disposition images Pi in the background image Pb (for example, number of dispositions, disposition spacing, and disposition shape), the overall hue and tone of the disposition images Pi, and the attribute of the subject (for example, type, age group, gender, size, pose, and gesture).

The learning model is a model for style setting that is constructed by performing the machine learning using, as training data, a set of at least one of the background image Pb (which may be background image Pb on which the disposition image Pi is disposed) or the disposition image Pi, which are used in the past or prepared for learning, and an appropriate style of the text information Tx.

Alternatively, the correspondence relationship between at least any one of the first information or the second information, that is, the image analysis results for only the background image Pb, the background image Pb on which the disposition image Pi is disposed, and the disposition image Pi, and the style of the text information Tx (refer to FIG. 4) is stored as data. With reference to the correspondence relationship, a style corresponding to the image analysis result indicated by at least one of the first information or the second information may be selected.

### About Third Modification Example

As a modification example other than the first and second modification examples described above, an aspect can be employed, based on the blank region Pv in the background image Pb, in which the number of characters of the text indicated by the text information Tx disposed in the blank region Pv is controlled. In this case, the processor 10a performs the control of generating the text information Tx based on the attribute information related to the blank region Pv generated in the background image Pb, as the information related to the background image Pb.

The processor 10a refers to the correspondence relationship between the attribute information of the blank region Pv and the number of characters and the display size of the text (FIG. 5) to decide the number of characters or the like of the text indicated by the text information Tx disposed in the blank region Pv.

The correspondence relationship described above does not simply define a correspondence relationship in which a text having a larger number of characters can be disposed as the size of the blank region Pv is larger. For example, in a case where the position of the blank region Pv is near the center of the background image Pb, the correspondence relationship described above may also include a corresponding relationship in which the number of characters of the text is extremely small and the display size is large. Even from the viewpoint of the position of the blank region Pv described above, in a case where the number of characters is controlled, for example, it is possible to generate the text information Tx in which the subject, the scene, and the like of the disposition image Pi are mentioned in a more concise manner with a text (sentence) having a smaller number of characters at a conspicuous place on the background image Pb.

More specifically, the processor 10a acquires the attribute information of the blank region Pv, such as the area, occupation ratio (area basis), and position (for example, central portion, upper portion, or lower portion of background image Pb) of the blank region Pv in the background image Pb. The processor 10a refers to the correspondence relationship described above to decide the style including the number of characters and character size of the text indicated by the text information for the text information Tx disposed in the blank region Pv.

In a case where a plurality of blank regions Pv are present in which the text information Tx can be disposed, the user may be able to select, from the plurality of blank regions Pv, the blank region Pv in which the text information Tx is disposed. Alternatively, the processor 10a may automatically select the blank region Pv in which the text information Tx is disposed in accordance with the attribute information (specifically, area or position) of each blank region Pv.

### About Fourth Modification Example

In the first embodiment described above, the disposition method of the generated text information Tx may be controlled. As a fourth modification example of the first embodiment, a form will be described in which the disposition method of the text information Tx is controlled.

The processor 10a executes the decision of the disposition method based on at least any one of the first information (image analysis result of at least one of the layout of the disposition image Pi in the background image Pb or the background image Pb) or the second information (image analysis result of the disposition image Pi). That is, the disposition of the text information Tx in the output image Po is decided based on at least any one of the first information or the second information.

In this case, the processor 10a decides the disposition of the text information Tx based on the image (at least any one of the disposition image Pi or the background image Pb) used to generate the generated text information Tx and the disposition thereof. The decided disposition is at least any one of the disposition position of the text information Tx or the disposition direction thereof.

In order to decide the disposition position of the text information Tx, the processor 10a deciding the disposition specifies whether the disposition image Pi used to generate the text information Tx is any one of the plurality of disposition images Pi disposed on the background image Pb or one disposition image Pi disposed on the background image Pb. The information related to the disposition image Pi used to generate the text information Tx may be held by a storage unit at the time of generating the text information Tx. The processor 10a collates the information related to the disposition image Pi used to generate the text information Tx with the table for determination.

As shown in FIG. 6, the table for determination defines the disposition position of the text information Tx in accordance with whether the disposition image Pi used to generate the text information Tx is plural or one.

In that case, from the above collation, for example, in a case where the plurality of disposition images Pi are used, the processor 10a decides the disposition position of the text information Tx in the upper portion of the background image Pb. Further, for example, in a case where one disposition image Pi is used, the processor 10a decides the disposition position of the text information Tx to be around the disposition image Pi or around the subject in the disposition image Pi.

In the table for determination, in a case where the disposition position of the text information Tx is defined at a position according to the subject, the processor 10a specifies the subject in the disposition image Pi to specify the position around the subject.

Accordingly, it is possible to dispose the text information Tx at a position where the subject and the text information Tx can be easily associated with each other, such as the periphery of the subject. In a case where the plurality of subjects are present in the disposition image Pi, the processor 10a selects a specific subject based on a preset rule (for example, subject having a maximum size in image, subject present in center of image, or subject positioned in center of a plurality of subjects), and decides the disposition position of the text information Tx around the selected subject.

In deciding the disposition direction, among the disposition methods of the text information Tx, the processor 10a performs control of determining the inclination (rotation angle) of the disposition image Pi, which is used to generate the text information Tx, on the background image Pb, and rotating the text information Tx according to the rotation angle. Further, instead of determining the inclination of the disposition image Pi, the inclination of the subject in the disposition image Pi may be determined, and the text information Tx may be inclined in accordance with the inclination.

Although the specific embodiment of the present invention has been described above, the above embodiment is merely an example for ease of understanding of the present invention, and is not intended to limit the present invention. That is, the present invention may be changed or improved from the embodiment described below without departing from the spirit of the present invention. Further, the present invention includes an equivalent thereof. Furthermore, the embodiment of the present invention can include a form in which the above embodiment and one or more of the following modification examples are combined.

### About Computer Constituting Text Information Generation Device

In the above embodiment, the text information generation device according to the embodiment of the present invention is configured of the computer that is directly used by the user, such as the terminal (client terminal) owned by the user. However, the present invention is not limited thereto, and the text information generation device according to the embodiment of the present invention may be configured of a computer that can be indirectly used by the user, for example, a server computer. The server computer may be, for example, a server computer for a cloud service, specifically, a server computer for an application service provider (ASP), software as a service (Saas), platform as a service (PaaS), or infrastructure as a service (IaaS). In this case, in a case where necessary information is input to the client terminal, the server computer performs various types of processing (calculation) based on the input information, and a calculation result is output to a client terminal side. That is, it is possible to use the function of the server computer constituting the text information generation device according to the embodiment of the present invention on the client terminal side.

### About Configuration of Processor

The processor provided in the text information generation device according to the embodiment of the present invention includes various processors. Examples of the various processors include a CPU that is a general-purpose processor that executes software (program) and functions as various processing units.

Moreover, various processors include a programmable logic device (PLD), which is a processor of which a circuit configuration can be changed after manufacturing, such as a field programmable gate array (FPGA).

Furthermore, the various processors include a dedicated electric circuit that is a processor having a circuit configuration specially designed for executing a specific process, such as an application specific integrated circuit (ASIC).

Further, one functional unit included in the text information generation device according to the embodiment of the present invention may be configured of one of the various processors described above. Alternatively, one functional unit of the text information generation device according to the embodiment of the present invention may be configured of a combination of two or more processors of the same type or different types, for example, a combination of a plurality of FPGAs or a combination of an FPGA and a CPU.

Further, the plurality of functional units included in the text information generation device according to the embodiment of the present invention may be configured of one of the various processors, or two or more of the plurality of functional units may be collectively configured of one processor.

Further, as in the above embodiment, a form may be employed in which one processor is configured of a combination of one or more CPUs and software, and the processor functions as the plurality of functional units.

Further, for example, as represented by a system on chip (SoC) or the like, a form may be employed in which a processor that realizes the functions of the entire system including the plurality of functional units in the text information generation devices according to the embodiment of the present invention with one integrated circuit (IC) chip is used. Further, a hardware configuration of the various processors described above may be an electric circuit (circuitry) in which circuit elements, such as semiconductor elements, are combined.

### EXPLANATION OF REFERENCES

10: text information generation device
10a: processor
10b: memory
10c: communication interface
10d: storage
10e: input device
10f: output device
21: reception unit
22: generation unit
23: decision unit
24: output unit
Pv: blank region
Pb: background image
Pi: disposition image
Po: output Image
Tx: text

What is claimed is:

1. A text information generation device that generates text information based on a background image and one or more images, the text information generation device comprising:
a processor,
wherein the processor is configured to execute:
first acquisition processing of acquiring first information related to at least one of a layout of the image in the background image or the background image;
second acquisition processing of acquiring second information related to the image; and
generation processing of generating the text information based on the first information and the second information.

2. The text information generation device according to claim 1,
wherein the processor is configured to execute, in the generation processing, output processing of setting a style based on at least any one of the first information or the second information, and outputting the text information according to the style.

3. The text information generation device according to claim 2,
wherein the first information related to the background image is information related to a color pattern of the background image.

4. The text information generation device according to claim 1,
wherein the first information related to the layout is information related to a blank region in which the image is not disposed in the background image.

5. The text information generation device according to claim 4,
wherein the processor is configured to decide, in the generation processing, at least one of the number of characters of a text included in the text information or a display size of the text based on a size of the blank region.

6. The text information generation device according to claim 1,
wherein the processor is configured to generate, in the generation processing, the text information based on the first information related to the layout, a rule for generating the text information according to the layout, and the second information.

7. The text information generation device according to claim 1,
wherein, in a case where the layout is a layout in which two or more images of different sizes are disposed on the background image, the processor is configured to generate, in the generation processing, the text information based on at least the second information related to a largest image.

8. The text information generation device according to claim 1,
wherein, in a case where the layout is a layout in which two or more images of the same size are disposed on the background image, the processor is configured to generate, in the generation processing, the text information based on the second information related to each of the two or more images.

9. The text information generation device according to claim 1,
wherein the processor is configured to:
execute processing of generating an image attached with text information in which the text information is disposed in at least any one of the background image or the image; and
further execute processing of deciding a disposition method of a text indicated by the text information in the image attached with text information based on at least one of the first information or the second information.

10. A text information generation method of generating text information based on a background image and one or more images by a processor, the text information generation method comprising: by the processor,
a step of acquiring first information related to at least one of a layout of the image in the background image or the background image;
a step of acquiring second information related to the image; and
a step of generating the text information based on the first information and the second information.

11. A computer-readable recording medium on which a program for causing a computer to execute each of the steps included in the text information generation method according to claim 10 is recorded.
